(19) United States
(12) Patent Application Publication
(10) Pub. No.: US 2022/0158326 A1
(43) Pub. Date: May 19, 2022

(54) ANTENNA DISPOSITION IN COMPUTING DEVICES

(71) Applicant: Hewlett-Packard Development Company, L.P., Spring, TX (US)

(72) Inventors: Chien-Pai Lai, Taipei City (TW); He-Di Liu, Taipei City (TW); Po Chao Chen, Taipei City (TW); Chin Hung Ma, Taipei City (TW)

(73) Assignee: Hewlett-Packard Development Company L.P., Spring, TX (US)

(21) Appl. No.: 17/296,945

(22) PCT Filed: Aug. 8, 2019
(86) PCT No.: PCT/US2019/045635

§ 371 Date: May 25, 2021

(51) Int. Cl. H01Q 1/22; H01Q 19/22; H01Q 21/28

(52) U.S. Cl. CPC H01Q 1/2266; H01Q 21/28; H01Q 19/22

(57) ABSTRACT

Techniques for antenna disposition in computing devices are described, in an example, a knuckle hinge coupled to a first component allows rotation of the first component relative to a second component. The knuckle hinge may be separated from the first component by a gap. An antenna may be disposed on the first component.

### BACKGROUND

Computing devices, such as laptops, include antennas for wireless communication purposes. For instance, the antennas may be used to receive and transmit wireless signals, such as Wi-Fi™ signals and Bluetooth® signals. An antenna may be disposed within a part of a computing device.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1 illustrates a computing device including a knuckle hinge assembly to facilitate rotation of a first component relative to a second component, according to an example implementation of the present subject matter;

FIG. 2 illustrates a computing device having a display unit, a base unit, and an antenna disposed on the display unit, according to an example implementation of the present subject matter;

FIG. 3 illustrates a computing device having a first cover, a second cover, and an antenna disposed on the first cover, according to an example implementation of the present subject matter;

FIG. 4 illustrates a front view of a computing device having a plurality of knuckle hinge assemblies, according to an example implementation of the present subject matter;

FIG. 5(a) illustrates front view of a computing device having a first antenna and a second antenna disposed on a display cover of a computing device, according to an example implementation of the present subject matter;

FIG. 5(b) illustrates front view of a computing device having a first antenna and a second antenna disposed on a base cover of a computing device, according to an example implementation of the present subject matter; and

FIG. 5(c) illustrates front view of a computing device having a first antenna and a second antenna disposed on a base cover of a computing device, according to an example implementation of the present subject matter.

### DETAILED DESCRIPTION

Computing devices include antennas for wireless communication purposes. An antenna is disposed in or on a part of a computing device. In some cases, a slot is formed in a chassis of a display unit of the computing device and the antenna is disposed in the slot. The presence of the slot in the chassis reduces the strength of the chassis. Further, the slot is to be closed, such as using mylar, after disposition of the antenna in the slot. The provision of the slot in the chassis and the subsequent closure of the slot also increases the cost of manufacturing the chassis.

The present subject matter relates to disposition of antennas in computing devices. With the implementations of the present subject matter, computing devices can be provided with a chassis devoid of slots.

In accordance with an example implementation of the present subject matter, a computing device includes a knuckle hinge assembly to facilitate rotation of a first component relative to a second component. The first component may be, for example, a display cover of a display unit of the computing device and the second component may be, for example, a base cover of a base unit of the computing device. The knuckle hinge assembly may facilitate rotation of the display unit relative to the base unit about an axis. The axis may extend parallel to the directions in which the widths of the first component and the second component extend.

The knuckle hinge assembly may include a knuckle hinge. The knuckle hinge may be coupled to the first component, for example, through a leaf. Further, the knuckle hinge may face a portion of the first component and may be separated from the portion by the clearance gap. The portion of the first component may be part of a display cover of the first component. For instance, the display cover may include a rear housing and a front plate, and the portion of the first component may be part of the front plate. The clearance gap may be provided, for example, to prevent friction between the first component and the knuckle hinge during rotation of the first component.

In an example, an antenna may be disposed on the first component, such that the disposed antenna is separated from the knuckle hinge by the clearance gap. For instance, a part of the antenna may be disposed on the portion of the first component, which is separated from the knuckle hinge by the clearance gap. Thus, the part of the antenna may face the knuckle hinge and may be separated from the knuckle by the clearance gap.

The present subject matter eliminates the provision of slots for antennas in chassis of computing devices, as the antenna is disposed on a surface of a component, such as a display cover or a base cover. Thus, the manufacturing of the chassis is simplified. Also, since the antenna is disposed such that it faces a knuckle hinge and since the antenna is separated from the knuckle by a clearance gap, the knuckle hinge may reflect signals emitted by the antenna and the signals to be received by the antenna. Therefore, the present subject matter facilitates increasing gain of the antenna. Further, the present subject matter leverages a clearance gap between the component and a hinge assembly for reflection of the signals. Therefore, a separate clearance gap for reflection of signals is not to be provided. Thus, the present subject matter facilitates disposition of the antenna without increasing the size of the computing device of the computing device or its parts.

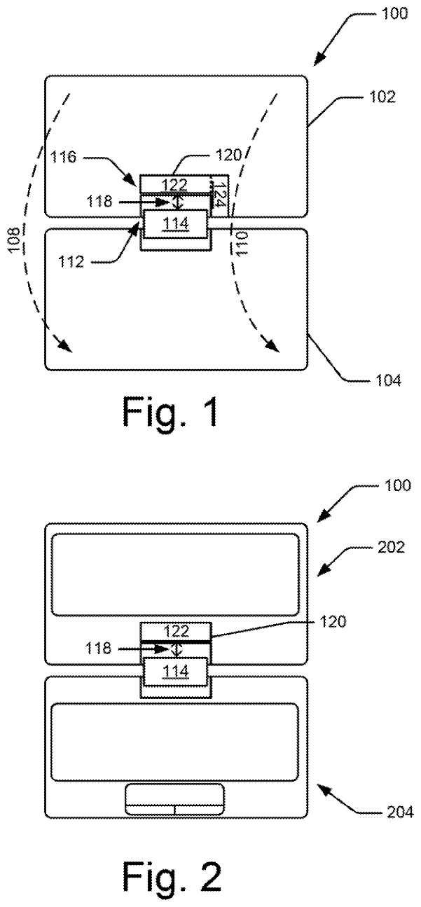

The present subject matter is further described with reference to FIGS. 1-5(c). It should be noted that the description and figures merely illustrate principles of the present subject matter. Various arrangements may be devised that, although not explicitly described or shown herein, encompass the principles of the present subject matter. Moreover, all statements herein reciting principles, aspects: and examples of the present subject matter, as well as specific examples thereof, are intended to encompass equivalents thereof.

Further, in the description provided below, a laptop is used, as an example of a computing device in which the antenna is disposed, to explain various aspects of the present subject matter. However, it is to be understood that the techniques of the present subject matter can be utilized for any type of computing device that includes an antenna and that has units that are rotatably coupled to each other using a hinge assembly

FIG. 1 illustrates a computing device 100 including a knuckle hinge assembly to facilitate rotation of a first component relative to a second component, according to an example implementation of the present subject matter. Examples of the computing device 100 include a laptop and a notebook. The computing device 100 may include a first component 102 and a second component 104, which are moveable with respect to each other, during the course of operation and usage of the computing device 100. The first component 102 may be, for example, a display unit of the computing device 100 or a cover of the display unit. The cover of the display unit may be referred to as a display cover. The second component 104 may be, for example, a base unit of the computing device 100 or a cover of the base unit. The cover of the base unit may also be referred to as a base cover. In another example, the first component 102 may be the base cover and the second component 104 may be the display cover.

The first component 102 may be rotatable relative to the second component 104, as illustrated by arrows 108 and 110. For instance, the display unit can be closed on the base unit by rotating the display unit towards the base unit and can be opened by rotating the display unit away from the base unit. To facilitate the rotation, the computing device 100 may include a knuckle hinge assembly 112. The knuckle hinge assembly 112 may include a knuckle hinge 114 that is coupled to both the first component 102 and the second component 104. In an example, the knuckle hinge 114 may be located between proximately-located edges of the first component 102 and the second component 104. The knuckle hinge 114 may face a first portion 116 of the first component 102. The knuckle hinge 114 may be separated from the first portion 116 by a gap 118.

The computing device 100 further includes an antenna 120, which may include a first antenna part 122. In an example, the first antenna part 122 is disposed on the first portion 116. The antenna 120 may extend beyond the first portion 116. For instance, the antenna 120 may include a second antenna part 124 that is disposed on another portion (not marked in FIG. 1) of the first component 102. Due to the disposition of the first antenna part 122 on the first portion 116, the first antenna part 122 faces the knuckle hinge 114. Therefore, the wireless signals emitted by the first antenna part 122 may cross the gap 118 and reach the periphery of the knuckle hinge 114. The wireless signals may be reflected by the knuckle hinge 114, thereby acting as a reflector to the antenna 120. Thus, the disposition of the first antenna part 122 facilitates increasing the gain of the antenna 120.

FIG. 2 illustrates the computing device 100 having a display unit 202, a base unit 204, and an antenna disposed on the display unit 202, according to an example implementation of the present subject matter. The display unit 202 may be rotatable relative to the base unit 204. To facilitate the rotation, the computing device 100 includes the knuckle hinge 114. The knuckle hinge 114 may be disposed between the display unit 202 and the base unit 204 and may be coupled to the display unit 202. In an example, the knuckle hinge 114 may be coupled to the display cover (not shown in FIG. 2) of the display unit 202.

The knuckle hinge 114 may be separated from the display unit 202 by the gap 118, interchangeably referred to as the clearance gap 118. In an example, a portion of the knuckle hinge 114 may be separated from the display unit 202 by the clearance gap 118. For instance, the knuckle hinge 114 may be substantially cylindrical in shape and the portion of the knuckle hinge 114 may be an outer circumferential surface (not numbered in FIG. 2) of the knuckle hinge 114.

The computing device 100 may further include the antenna 120. A part of the antenna 120, such as the first antenna part 122, is separated from the knuckle hinge 114 by the clearance gap 118.

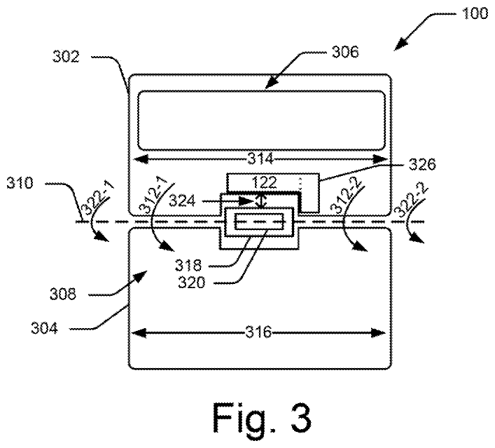

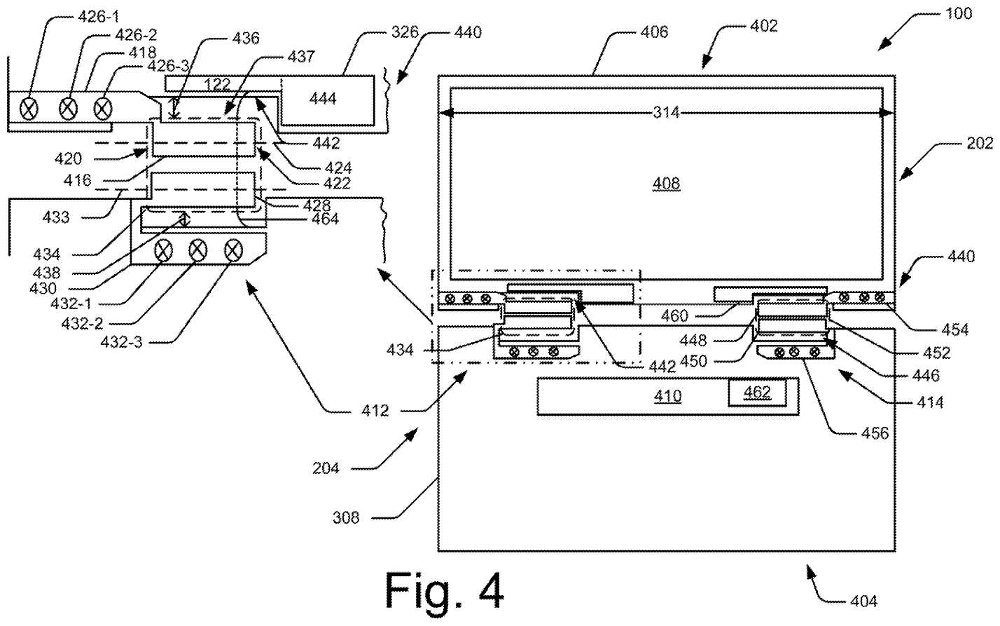

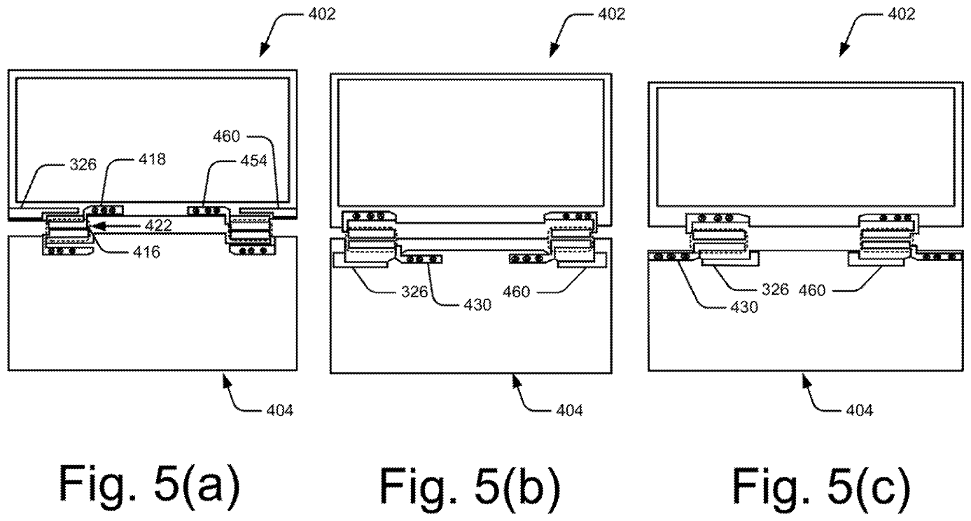

FIG. 3 illustrates the computing device 100 having a first cover 302, a second cover 304, and an antenna disposed on the first cover 302, according to an example implementation of the present subject matter. As illustrated in FIG. 3, the first cover 302 may be the display cover and the second cover 304 may be the base cover. In another example, the first cover 302 may be the base cover and the second cover 304 may be the display cover. The first cover 302 may include a first surface 306. If the first cover 302 is the display cover, the first surface 306 may be the surface of a plate of the first cover 302. The plate may be, for example, a front plate of the first cover 302, as will be explained with reference to FIG. 4. If the first cover 302 is the base cover, the first surface 306 may be an interior surface of the base cover on which components of the base unit 204 can be mounted, as will be explained with reference to FIG. 5(b).

The second cover 304 may include a second surface 308. If the second cover 304 is the display cover, the second surface 308 may be the surface of a plate of the first cover 302. If the second cover 304 is the base cover, the second surface 308 may be the interior surface of the base cover.

The first cover 302 may be rotatably coupled to the second cover 304, For instance, the first cover 302 can rotate about a first axis 310. The rotation of the first cover 302 relative to the first axis 310 is illustrated by arrows 312-1 and 312-2. The first surface 306 and the first cover 302 may extend in width parallel to the first axis 310. A direction in which the first surface 306 and the first cover 302 extends in width is represented by an arrow 314.

The computing device 100 may further include a first knuckle hinge 318, which may be the same as the knuckle hinge 114. The first knuckle hinge 318 may include a knuckle 320. The knuckle 320 may be disposed between the first cover 302 and the second cover 304 and may be coupled to the first cover 302. The knuckle 320 may be rotatable about the first axis 310. For instance, the knuckle 320 may be cylinder-shaped and may extend in length along the first axis 310. Accordingly, the knuckle 320 may rotate about the first axis 310 to allow rotation of the first cover 302 relative to the second cover 304. For instance, if the first cover 302 is the display cover, when a force is applied on the display unit 202 by a user of the computing device 100 for rotating the display unit 202, the force applied may be transferred to the knuckle 320. This causes rotation of the knuckle 320 about the first axis 310, as illustrated by arrows 322-1 and 322-2.

The first knuckle hinge 318 may be separated from the first cover 302 by a clearance gap 324, which may be the same as the clearance gap 118. A first antenna 326 may be disposed on the first surface 306. The first antenna 326 may be separated from the first knuckle hinge 318 by the first clearance gap 324. For instance, the first surface 306 may include the first portion 116 (not shown in FIG. 3) and the first antenna part 122 of the first antenna 326 may be disposed on the first portion 116.

The various aspects of the present subject matter will be explained in greater detail with respect to FIGS. 4-6.

FIG. 4 illustrates a front view of the computing device 100 having a plurality of knuckle hinge assemblies, according to an example implementation of the present subject matter. Here, various components of the computing device 100, such as screen of the display unit 202, keyboard, and mousepad, have been obscured to illustrate the internal components of the computing device 100. A display cover 402 and a base cover 404 are shown 180° apart from each other. The display cover 402 may include a plate 406 and a housing (not numbered in FIG. 4). The housing may also be referred to as a chassis of the display unit 202. The plate 406 may be referred to as the front plate 406 and the housing may be referred to as the rear housing as, in a direction in which a viewer views the content displayed on the screen (“viewing direction”), the plate 406 is in front of the housing. In an example, first surface 306, on which the first antenna 326 is disposed, may be a surface of the front plate 406 that faces away from the rear housing.

The front plate 406 may be a metallic plate and may be substantially rectangular in shape. Further, the front plate 406 may have a blank area 408 around its center. The blank area 408 may also be substantially rectangle-shaped. Through the blank area 408, a display screen, such as a liquid crystal display (LCD) screen, may be exposed, to allow the viewer to view content displayed on the display screen. In an example, the computing device 100, may include a plate (not shown in FIG. 4) disposed on top of the front plate 406 to enhance the visual appearance of the computing device 100. The top plate may have a shape similar to that of the front plate 406 and is referred to as a bezel.

The base cover 404 may be the second cover 304 (explained with reference to FIG. 3). In an example, the base cover 404 may be a housing in which other components of the base unit 204, such as a motherboard 410 and keyboard, can be accommodated. On the base cover 404, a top plate (not shown in FIG. 4) may be mounted. Accordingly, the other components of the base unit 204 may be secured in a gap formed between the base cover 404 and the top plate.

The computing device 100 may also include a plurality of knuckle hinge assemblies, interchangeably referred to as hinge assemblies in the below description. In an example, the hinge assemblies facilitate a complete 360° rotation of the display unit 202 relative to the base unit 204. The plurality of hinge assemblies may include a first hinge assembly 412 and a second hinge assembly 414. The first hinge assembly 412 and the second hinge assembly 414 may be similar in structure and functions to the knuckle hinge assembly 112. The first hinge assembly 412 may include a first knuckle 416, which may be the same as the knuckle 320. In addition, the first hinge assembly 412 may include a first leaf 418 coupled to the first knuckle 416. The first leaf 418 may extend laterally from the first knuckle 416. For instance, the first knuckle 416 may be substantially cylindrical in shape and may have a first axial end 420 and a second axial end 422. The first leaf 418 may be coupled to the first axial end 420, as illustrated, or to the second axial end 422. The first leaf 418 may be coupled to the first knuckle 416 using a known coupling technique, such as welding. Alternatively, the first knuckle 416 and the first leaf 418 may be manufactured as a single piece.

In an example, the first knuckle 416 may be hollow. For instance, if the first, knuckle 416 is cylinder-shaped, an opening may extend through the body of the first knuckle 416 and along the length of the first knuckle 416. Accordingly, the first knuckle 416 may resemble a loop. A first pin (not shown in FIG. 4) may pass through the opening in the first knuckle 416. Thus, first knuckle 416 may be mounted on the first pin and be rotatable about the first pin. Thus, the first pin forms an axis 424 about which the first knuckle 416 can rotate.

The first leaf 418 may couple the first knuckle 416 with the display cover 402. For the coupling, the first leaf 418 may be fastened to the display cover 402 using fasteners, such as screws 426-1, 426-2, and 426-3. Since the display cover 402 is coupled to the first knuckle 416, the display cover 402 can be rotated about the axis 424, When the user of the computing device 100 applies a force on the display unit 202 to rotate the display unit 202 relative to the base unit 204, the display cover 402, the first leaf 418, and the first knuckle 416 rotate about the axis 424. The axis 424, about which the display unit 202 can be rotated, may be referred to as the display axis 424. The display axis 424 may be the first axis 310 explained with reference to FIG. 3, if the first cover 302 is the display cover 402.

In an example, the first hinge assembly 412 may also include a second knuckle 428. The second knuckle 428 may be disposed between the display cover 402 and the base cover 404. Also, the second knuckle 428 may be disposed between the first knuckle 416 and the base cover 404. The first hinge assembly 412 may also include a second leaf 430 coupled to the second knuckle 428. The second knuckle 428 and the second leaf 430 may have a structure similar to that of the first knuckle 416 and the first leaf 418 respectively. Further, the second leaf 430 may be coupled to the second knuckle 428 in a manner similar to the coupling between the first leaf 418 and the first knuckle 416. The second leaf 430 may be coupled to the base cover 404 using fasteners, such as screws 432-1, 432-2, and 432-3.

A second pin (not shown in FIG. 4) may pass through an opening in the second knuckle 428. The second pin may extend along an axis 433, which may be parallel to the display axis 424, as illustrated, Thus, the base cover 404, the second leaf 430, and the second knuckle 428 can rotate about the axis 433. The axis 433, about which the base unit 204 can rotate, may also be referred to as the base axis 433. If the base cover 404 is the second cover 304, the base axis 433 may be referred to as a second axis, which is an axis about which the second cover 304 can rotate.

The first hinge assembly 412 further includes a hinge housing 434 in which the first knuckle 416 and the second knuckle 428 are enclosed. The hinge housing 434 may be substantially cylindrical in shape and may extend in length parallel to the first knuckle 416 and the second knuckle 428. In an assembled state of the computing device 100, the hinge housing 434 may be visible, while the first knuckle 416 and the second knuckle 428 may be hidden from view. However, in FIG. 4, the hinge housing 434 is obscured to illustrate the knuckles and their coupling with the leaves. The hinge housing 434, the first knuckle 416, and the second knuckle 428 may be collectively referred to as a first knuckle hinge or a first hinge, which may be the same as the first knuckle hinge 318.

In an example, a relative motion exists between the hinge housing 434 and the display cover 402 during the rotation of the display cover 402 about the display axis 424. Similarly, a relative motion exists between the hinge housing 434 and the base cover 404 during the rotation of the base cover 404 about the base axis 433. The relative motion may cause wear of the surfaces of the hinge housing 434, the display cover 402, and the base cover 404 if the surface of the hinge housing 434 is in contact with that of the display cover 402 and that of the base cover 404. To prevent wear of the surfaces, a clearance gap 436 may be provided between the hinge housing 434 and the display cover 402. The clearance gap 436 may exist, for example, between an outer circumferential surface 437 of the hinge housing 434 and the display cover 402. The clearance gap 436 may be, for example, the clearance gap 118, if the display cover 402 is the first component 102. A clearance gap 438 may be provided between the hinge housing 434 and the base cover 404. If the base cover 404 is the first component 102, the clearance gap 438 may be the clearance gap 118 explained with reference to FIGS. 1-3. In an example, the clearance gaps 436 and 438 may have a size in a range of 30-45 mm.

To provide the clearance gap 436 between the first hinge 318 and the display cover 402, in an example, some portions of a bottom section 440 of the front plate 406 may cut out to form a well, into which a hinge may be received. For instance, on the bottom section 440, a well may be formed in the portion 442 that faces the first hinge 318. Similarly, a well may be formed also in the rear housing of the display cover 402, The portion 442 may be the first portion 116 explained with reference to FIG. 1.

In an example, the first antenna 326 may be disposed on the front plate 406. The first antenna 326 may be disposed such that at least a portion of the first antenna 326 faces the first hinge 318. For instance, the first antenna part 122 may be disposed on the portion 442. Thus, the first antenna part 122 is separated from the first hinge 318 by the clearance gap 436. In FIG. 4, the first antenna part 122 is shown slightly displaced from the edge of the portion 442 to clearly illustrate structure of the first antenna 326. However, the first antenna 326 may be disposed such that the first antenna part 122 extends along the edge of the portion 442.

The disposition of first antenna part 122 on the portion 442 causes the wireless signals emitted by the first antenna part 122 to cross the clearance gap 436 and to be incident on the first hinge 318. If the hinge housing 434 is made of a metal, the hinge housing 434 reflects the incident wireless signals. If the hinge housing 434 is made of a non-metal, such as plastic, it may not reflect the wireless signals. In such a case, the wireless signals may penetrate the hinge housing 434, and can be reflected by the first knuckle 416, which is made of a metal. Similarly, the wireless signals emitted by other components, such as a wireless router and a mobile phone, in the vicinity of the computing device 100 may also be incident on the hinge housing 434 or the first knuckle 416. Such wireless signals may be reflected by the hinge housing 434/first knuckle 416. The reflected wireless signals can be picked up by the first antenna part 122. Thus, the hinge housing 434/first knuckle 416 acts as a reflector for the first antenna 326, and helps in increasing the gain of the first antenna 326.

In addition to the first antenna part 122, the first antenna 326 may include a second antenna part 444. The first antenna 326 may be disposed on the front plate 406 such that the second antenna part 444 is adjacent to the first portion 116 in the widthwise direction 314 of the front plate 406. Further, the first antenna part 122 may be disposed between the second antenna part 444 and the first leaf 418 on the front plate 406. In an example, the second antenna part 444 may have a greater cross-sectional area as compared to that of the first antenna part 122, as illustrated in FIG. 4. This is because the second antenna part 444 is disposed on a portion of the bottom section 440 that has a greater height than that of the portion 442. The first antenna part 122 may be referred to as a stem portion 122 and the second antenna part 444 may be referred to as a base portion 444, Further, the first antenna part 122 and the second antenna part 444 may be formed as integral to each other.

It s to be noted that the shape of the first antenna 326 explained herein is an example, and the shape may be modified based on size and shape of the surface on which it is to be disposed, size of the display cover 402, size of the knuckle hinge assemblies, and the like.

In addition to the first hinge assembly 412, the computing device 100 may also include the second hinge assembly 414. Similar to the first hinge assembly 412, the second hinge assembly 414 may also be disposed between the display cover 402 and the base cover 404. The first hinge assembly 412 and the second hinge assembly 414 may be disposed opposite each other in a widthwise direction 314 of the display unit 202 and a widthwise direction of the base unit 204. The second hinge assembly 414 may include a second knuckle hinge 446.

The second knuckle hinge 446 includes a third knuckle 448, a fourth knuckle 450, and a second hinge housing 452. The second hinge assembly 414 may also include a third leaf 454 and a fourth leaf 456. The third knuckle 448, the fourth knuckle 450, the second hinge housing 452, the third leaf 454, and the fourth leaf 456 may be similar to the first knuckle 416, the second knuckle 428, the hinge housing 434, the first leaf 418, and the second leaf 430 respectively in structure and may have similar functions. Further, the third knuckle 448 and the fourth knuckle 450 may be disposed offset along the display axis 424 and the base axis 433 from the first knuckle 416 and the second knuckle 428 respectively.

The second knuckle hinge 446 may be separated from the front plate 406 by a second clearance gap (not marked in FIG. 4 for the sake of clarity). Further, a second antenna 460 may be disposed on the front plate 406 such that the second antenna 460 is separated from the second knuckle hinge 446 by the second clearance gap. For instance, the second knuckle hinge 446 may face a portion of the front plate 406 and a part of the second antenna 460 may be disposed on that portion. The portion of the front plate 406 on which the part of the second antenna 460 is disposed may have shape and dimensions similar to that of the portion 442.

As mentioned earlier, the motherboard 410 of the computing device 100 may be housed in the base cover 404. The motherboard 410 may include a wireless local area network (WLAN) module 462, which can allow the computing device 100 to connect to a Wi-Fi™ network for communication over the Internet. The WLAN module 462 is to be connected to the antennas to receive and transmit wireless signals. The WLAN module 462 may be connected to the antennas using cables, also referred to as antenna cables. In an example, the antenna cables may be routed around the hinge assemblies. For instance, a first antenna cable 464 connecting the first antenna 326 with the WLAN module 462 may be routed around the hinge housing 434 and be connected to the WLAN module 462. It may be noted that, in the present subject matter, the antennas are disposed closer to the WLAN module 462 as compared to the techniques in which the antennas are disposed in slots in the chassis. Therefore, the present subject matter reduces the length of the antenna cables.

Although, in FIG. 4, the first cover 302, i.e., the cover on which the first antenna 326 is disposed is explained as being the display cover 402, in some cases, the first cover 302 may be the base cover 404. Further, the regions of the covers on which the leaves are coupled may be different from that illustrated in FIG. 4. These aspects will be explained with reference to FIGS. 5(a)-(c).

FIG. 5(a) illustrates front view of the computing device 100 having the first antenna 326 and the second antenna 460 disposed on the display cover 402, according to an example implementation of the present subject matter. As illustrated, here, the first leaf 418 is connected at the second axial end 422 of the first knuckle 416. Also, here, the positions of the first antenna 326 and the first leaf 418 are reversed as compared to that illustrated in FIG. 4. Similarly, the positions of the second antenna 460 and the third leaf 454 are reversed compared to that illustrated in FIG. 4.

FIG. 5(b) illustrates front view of the computing device 100 having the first antenna 326 and the second antenna 460 disposed on the base cover 404, according to an example implementation of the present subject matter. Here, the base cover 404 may be the first cover 302 and the display cover 402 may be the second cover 304. Accordingly, the base axis 433 (not shown in FIG. 5(b)), about which the base cover 404 rotates, may be the first axis 310 and the display axis 424 (not shown in FIG. 5(b) may be the second axis. Further, the first surface 306, on which the antennas are disposed, may be an interior surface of the base cover 404 on which the components of the base unit 204 are mounted. Also, the first portion 116 may be part of the interior surface of the base cover 404 and the first clearance gap 118 may be the gap between the first knuckle hinge 318 and the first portion 116.

FIG. 5(c) illustrates front view of the computing device 100 having the first antenna 326 and the second antenna 460 disposed on the base cover 404, according to an example implementation of the present subject matter. Here, the positions of the second leaf 430 and the first antenna 326 may be reversed as compared to that in FIG. 5(b). Similarly, the positions of the fourth leaf 456 and the second antenna 460 may be reversed as compared to that in FIG. 5(b).

Although FIGS. 4-5(c) are explained with reference to examples in which the display unit 202 rotates about an axis that is different from an axis about which the base unit 204 can rotate, it is to be understood that the present subject matter can be implemented in scenarios where both the display unit 202 and the base unit 204 have a common axis of rotation.

The present subject matter eliminates the use of slots for antenna in chassis of computing devices, as the antenna is disposed on a component, such as a display cover or a base cover. Thus, the manufacturing of the chassis is simplified. Since the antenna is disposed to face a knuckle hinge and since the antenna is separated from the knuckle by a clearance gap, the knuckle hinge may reflect signals emitted by the antenna and the signals to be received by the antenna. Therefore, gain of the antenna can be increased. Further, in the present subject matter, a clearance gap that is part of the existing design of computing devices is leveraged for reflection of the signals. Therefore, a separate clearance gap for reflection of signals is not to be provided. Thus, an increase in the size of the computing device or its parts is prevented.

Although examples and implementations of present subject matter have been described in language specific to structural features and/or methods, it is to be understood that the present subject matter is not necessarily limited to the specific features or methods described. Rather, the specific features and methods are disclosed and explained in the context of a few example implementations of the present subject matter,

What is claimed is:

1. A computing device comprising:
a first component;
a second component;
a knuckle hinge assembly to allow rotation of the first component relative to the second component, the knuckle hinge assembly comprising a knuckle hinge coupled to the first component and to the second component, wherein the knuckle hinge is to face a first portion of the first component and is separated from the first portion of the first component by a gap; and
an antenna comprising a first antenna part, the first antenna part being disposed on the first portion of the first component.

2. The computing device of claim 1, comprising:
a display unit comprising a display cover and a display screen; and
a base unit having a base cover, wherein the first component is the display cover and the second component is the base cover, and wherein the display cover comprises:
a rear housing; and
a front plate, the rear housing and the front plate enclosing an opening in which the display screen is to be housed, wherein the antenna is disposed on the front plate.

3. The computing device of claim 1, comprising a base unit having a base cover, wherein the first component is the base cover.

4. The computing device of claim 3, wherein the first portion of the first component is on a surface of the base cover on which components of the base unit are mounted.

5. The computing device of claim 1, wherein the antenna comprises a second antenna part formed integral to the first antenna part, the second antenna part being disposed on a second portion of the first component, the second portion being adjacent to the first portion in a widthwise direction of the first component.

6. The computing device of claim 1, wherein the knuckle hinge comprises:
a first knuckle;
a second knuckle; and
a knuckle housing enclosing the first knuckle and the second knuckle, and wherein the knuckle hinge assembly further comprises:
a first leaf coupling the first knuckle with the first component; and
a second leaf coupling the second knuckle with the second component.

7. A computing device comprising:
a display unit;
a base unit;
a knuckle hinge to allow rotation of the display unit relative to the base unit, the knuckle hinge being disposed between the display unit and the base unit and being coupled to the display unit, wherein the knuckle hinge is separated from the display unit by a clearance gap; and
an antenna disposed on the display unit, wherein a part of the antenna is separated from the knuckle hinge by the clearance gap.

8. The computing device of claim 7, wherein the base unit comprises a wireless local area network (WLAN) module, and wherein the computing device comprises an antenna cable connecting the antenna and the WLAN module, the antenna cable being routed around the knuckle hinge.

9. The computing device of claim 7, wherein the knuckle hinge comprises:
a knuckle; and
a knuckle housing enclosing the knuckle, wherein the knuckle housing is made of a metal, is to receive wireless signals emitted by the antenna through the clearance gap, and is to reflect the wireless signals.

10. The computing device of claim 9, wherein the knuckle is cylinder-shaped and has an axis about which the display unit is rotatable, and wherein the computing device further comprises:
a leaf coupled to an axial end of the km.

11. A computing device comprising:
a first cover rotatably coupled to a second cover, the first cover being rotatable about a first axis, wherein the first cover comprises a first surface that extends in width parallel to the first axis;
the second cover;
a first knuckle hinge comprising a first knuckle, the first knuckle being disposed between the first cover and the second cover, rotatable about the first axis, and coupled to the first cover, wherein the first knuckle hinge is separated from the first cover by a first clearance gap; and
a first antenna disposed on the first surface and separated from the first knuckle hinge by the first clearance gap.

12. The computing device of claim 11, wherein the first knuckle hinge further comprises a second knuckle, the second knuckle being disposed between the first cover and the second cover, rotatable about a second axis, and coupled to the second cover, to allow rotation of the second cover relative to the first cover about the second axis, and wherein the first knuckle hinge is part of a first knuckle hinge assembly that further comprises:
a first pin extending in length along the first axis, wherein the first knuckle is mounted on the first pin for rotation about the first axis;
a first leaf coupling the first knuckle with the first cover;
a second pin extending in length along the second axis, wherein the second knuckle is mounted on the second pin for rotation about the second axis; and
a second leaf coupling the second knuckle with the second cover.

13. The computing device of claim 12, wherein the first antenna comprises a first antenna part and a second antenna part, wherein the first antenna part faces the first knuckle hinge and is disposed between the second antenna part and the first leaf on the first cover.

14. The computing device of claim 13, wherein the first antenna part and the second antenna part are integral to each other and wherein the second antenna part has a greater cross-sectional area than that of the first antenna part.

15. The computing device of claim 11, comprising:
a second knuckle hinge disposed between the first cover and the second cover and separated from the first cover by a second clearance gap; and
a second antenna disposed on the first surface and separated from the second knuckle hinge by the second clearance gap.
